(19) United States
(12) Patent Application Publication
(10) Pub. No.: US 2023/0045408 A1
(43) Pub. Date: Feb. 9, 2023

(54) System and Method for Dynamic Knowledge Transition

(71) Applicant: Cognizant Technology Solutions India Pvt. Ltd., Chennai (IN)

(72) Inventors: Srinivasan Thiagarajan, Chennai (IN); Surendranathan Ardhanari, Chennai (IN); Marilyn Jacob, Coimbatore (IN); Sadhana Sadasivam, Coimbatore (IN); Sudha Gurlhosur, Pune (IN); Mosheca Ravichand, Chennai (IN); Prachi Raut, Pune (IN); Kushagra Saxena, Gurgaon (IN); Sridhara Nagamangala Ranganath, Mysore (IN)

(21) Appl. No.: 17/873,330

(22) Filed: Jul. 26, 2022

(30) Foreign Application Priority Data
Jul. 29, 2021 (IN) 202141034163

(51) Int. Cl. G06N 5/02; G06N 5/04

(52) U.S. Cl. CPC G06N 5/022; G06N 5/043

(57) ABSTRACT

The present invention relates to a system and method for creating artificial intelligence-based knowledge bot application. The objective is to cater to various needs of knowledge transition at organizational level. Accordingly, the bot application can collect and extract knowledge from transition artifacts related to multiple applications in any format. Availability of existing knowledge or standard keys in collected artifacts is assessed along with associated knowledge gaps using a machine learning approach.

### FIELD OF INVENTION

The subject matter described herein, in general, relates to system and method for knowledge transition, and, in particular, relates to system and method generated artificial intelligence-based bot for facilitating knowledge transition.

### BACKGROUND OF INVENTION

Generally speaking, transition of application development and maintenance service poses a formidable challenge for major corporations/business entities interplaying with various vendors to improve their business processes. This may require certain amount of flexibility in making the overall process of such transition smooth, uninterrupted, and effortless.

Currently, in a typical service organizational set up, providing software services for plurality of applications to a customer involves a humongous task of transferring knowledge from documents held by customer themselves and customer's previous vendor. When done manually, extracting knowledge from plethora of documents associated with each application is a time consuming, tedious, inefficient, less reliable, inherently error-prone task, which is further exacerbated by the difficulty of identifying gaps if knowledge transition is not handled well.

Further, the knowledge transfer phase requires extensive personal interaction between individuals of interested organizations, which again is an expensive proposition. Even real time interaction with teams at remote locations or different geographies may be difficult because of time differences, which may prolong the process of knowledge transfer. Thus, given the enormity of manual processing involved along with challenges of managing cost and time, ensuring that all key knowledge areas are covered in artifacts is a herculean task. Precisely, it is humanly impossible to verify all content and transition knowledge accurately and cost-effectively for every application within almost implausibly imposing deadlines of the client.

Although attempts have been made to the problem of identifying and capturing information from artifacts/comprehensive documents to streamline the process, yet none so far have been effective enough to enable knowledge transition and exchange in a logically accessible manner. Further, when plurality of applications is being transitioned, it is important to prioritize their order of attention for knowledge acquisition sessions based on level of knowledge documentation available.

Furthermore, it is expected that knowledge is accessible in the explicit form or tacit form. Knowledge residing with individuals in tacit form increases people dependency in the process and hence need to be converted to explicit form, an enablement missing in contemporary solution.

It is also witnessed often during team onboarding that the transition happens in a distributed fashion. When new members join, their learning curve is high as there is major dependency on old team members for sharing knowledge. Thus, in absence thereof, the seamless onboarding of new resources becomes a challenge. Finally, with knowledge being distributed across various places, it is difficult to find relevant information, which further exacerbates the issue of knowledge extraction, collation, and dissemination amongst the knowledge seekers.

In the background of foregoing limitations, there exists a need for a system and method that is adept at addressing daunting task of knowledge transition between organizations at minimized cost within short time span without compromising on accuracy and veracity of overall process besides making the overall process seamlessly efficient and convenient.

### OBJECTS OF THE INVENTION

The primary object of the present disclosure is to provide an artificial intelligence enabled knowledge buddy bot for effective extraction of knowledge during knowledge transition phase.

Another object of this disclosure is to provide a knowledge buddy bot capable of automating process of knowledge transfer during knowledge transition thereby saving on both cost and time parameters.

Yet another object of the disclosure is to provide knowledge buddy bot capable of capturing, reading and collating documents from plurality of sources, promising enhanced precision and competence in knowledge transfer.

Yet other object of the present disclosure is to provide an economized system and method of creating AI based bot that can quickly identify knowledge gaps and inadequacies in knowledge transfer that may otherwise slip away unnoticed by company's personnel.

In yet another object, the disclosure provides a system and method for rapid knowledge transfer in an efficient manner even among remotely located organizations on a global level.

In still another object of present disclosure, the system and method orchestrate an automated bot that makes the knowledge transfer process much sophisticated and real-world usable.

In one other object of present disclosure, the system and method further facilitate optimized and logical inferring of information from plurality of documents to ensure end-to-end knowledge transition.

In yet another object of present disclosure, the system can identify the knowledge risks per application and suggesting focus areas during knowledge acquisition, shadow and reverse shadow phases of knowledge transition.

In still other object of present disclosure, the system and method enable access to knowledge in explicit or tacit form as the knowledge is documented from recorded knowledge transfer sessions.

In one another object of present disclosure, the system and method assist in seamless onboarding of new resources, making knowledge transfer simplified with reduced interdependency between individuals.

In yet another object of present disclosure, the system and method facilitate relevant knowledge extraction from various sources, collation, and easy dissemination by making the knowledge available in easily searchable form.

These and other objects will become apparent from the ensuing description of the present invention.

### BRIEF DESCRIPTION OF THE DRAWINGS

FIG. 1 is a functional workflow of generating knowledge bot application, in accordance with a preferred embodiment of the present disclosure.

### SUMMARY OF THE INVENTION

In first aspect of present disclosure, a system for knowledge transition is presented. The system comprises of a processor executing program instructions stored in a memory. The system further comprises of a transition planning module, implemented upon the processor (110), configured to ingest information in a given format from a plurality of sources; extract contextually relevant information from the ingested ‘information to check availability of one or more knowledge areas in a trained built-in library for complete knowledge transition, and identify knowledge gaps based on unavailability of the one or more knowledge areas.

In one other significant aspect of present disclosure, the transition planning module is configured to operate on an underlying machine learning model to extract the contextually relevant information and construct the trained built-in library.

In second significant aspect of present disclosure, a process for knowledge transition is disclosed. The method comprises steps of: ingesting information in a given format from a plurality of sources; extracting contextually relevant information from the ingested ‘information to check availability of one or more knowledge areas in a trained built-in library for complete knowledge transition, and identify knowledge gaps based on unavailability of the one or more knowledge areas. Here, the contextually relevant information is extracted by utilizing a machine learning model to further construct the trained built-in library.

### DETAILED DESCRIPTION OF THE EMBODIMENTS

In describing the preferred and alternate embodiments of the present disclosure, specific terminology is employed for the sake of clarity. The disclosure, however, is not intended to be limited to the specific terminology so selected, and it is to be understood that each specific element includes all technical equivalents that operate in a similar manner to accomplish similar functions. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. The disclosed embodiments are merely exemplary methods of the invention, which may be embodied in various forms.

The present disclosure is described below with reference to system and method for creating artificial intelligence-based bot application. In one significant aspect of present disclosure, the process of knowledge transition is facilitated by way of end-to-end botification of application services transition across the transition phases of planning, knowledge acquisition, shadow and reverse shadow phase. The instructions may be loaded into the system, which when executed upon such a computer-implemented system—a general purpose computer or a special purpose hardware-based computer system, creates means for the users to use and navigate the Knowledge bot during their knowledge acquisition phase.

According to its major aspects, the present disclosure in provides a system comprising knowledge buddy bot application (KBB) to automate current manual process of extracting knowledge from knowledge transfer sessions or application/infra-artifacts shared during knowledge transition phase. In one exemplary embodiment, the knowledge is extracted from artifacts or documents available in various forms—architecture, design documents, user manual, standard operating procedure, known error document, infrastructure or server configuration document, deployment document, component interaction document, process flow, data flow, upstream/downstream system images, knowledge transfer recording, WebEx session (audio and video) recording etc.

According to one exemplary embodiment, the system generated bot application is trained for multiple applications/technology. In one example embodiment, the trained bot may be made available and deployed as built-in libraries. However, in an event a new technology is discussed during a knowledge acquisition process, and no such trained built-in libraries exists, a book of knowledge (BOK) is generated with a set of new terms for training the bot on technological features of newly identified technology. There is also provided a feature of regular and periodic training of bot for such newly identified technology, as will be discussed in later sections.

Drawing from above, book of knowledge (BOK) is generated based on line of business, one or more standard key terms associated therewith, application group, categories such as functional, technical, process, infrastructure, operational and the like. In one further embodiment, one standard key term may be selected for multi applications as well. Upon creation of BOK and training of bot on created BOK, the bot is configured to extract knowledge associated with corresponding technological domain and identify associated knowledge gaps.

In one preferred embodiment of present disclosure, the system generated bot application 100 comprises of a transition planning module 10, knowledge analytics module 20, knowledge generation module 30 and a dashboard 40. The multiple modules (referring collectively to module 10, module 20, module 30 and module 40) of the system generated bot application 100 are implemented upon the processor 110 specifically programmed for executing instructions stored in the memory 120 for executing respective functionalities of the modules of the system 100 in accordance with various embodiments of the present invention.

The multiple modules (as referred above) are communicatively connected to extract knowledge out of artifacts shared by customer, identify knowledge gaps, perform a knowledge search, and generate a knowledge graph that assists analyzing, manipulating and drawing of complete information for knowledge transition.

To begin with, the transition planning module 10 allows ingestion and extraction of data into a data store. Accordingly, the transition planning module 10 is configured to support and ingest information contained in any of available file formats (Doc, Docx, Webex, XLXS, XLS, plain text, jpg, pdf, ppt, pptx, audio files (.wav, .mp3), video files (.m4a, .mp4), image file (.jpg, .jpeg, .png) etc.).

Further, the transition planning module 10 identifies the source type-FTP (file transfer protocol), local disk drive, and confluence. In accordance with one exemplary embodiment, single or multiple files may be uploaded at the same time. Most importantly, in an event any document is not desired to be uploaded by client in a vendor network, say for reasons of security and data privacy, the bot application 100 provisions briefcase utility, wherein light weight version of present bot application can be downloaded as an exe into customer network to identify knowledge gaps. The output generated can then be analyzed for knowledge extraction and further analytics.

Once the documents are uploaded in the transition planning module 10, content extraction is performed. Upon extracting the relevant content, information pertaining to availability status for all category keywords (process, functional, operational, technical, infrastructure) of a selected application can be deduced.

Post content extraction, the transition planning module 10 is configured to identify gaps in document. Consequently, based on application-LOB, cluster/track, wave, sub wave respective keyword list is projected to check for their status-available/unavailable across all the technical, functional, and process knowledge from the document. Thus, a provision to feed in customized standard keys or named entities to enhance the data dictionary of bot application 100 is suggested.

Further, the transition planning module 10 is configured to gather relevant information for unavailable subject areas through any probable source-such as webex (recorded audio or video sessions, documents, images), classroom, online sessions and the like or a combination thereof. Content extraction is performed along with image analytics and voice to text conversion (based on file type) to append the information to knowledge base. This valuable information is now uploaded in any of suitable formats (jpg, scanned doc, webex recording, text, pdf file etc.) along with supporting artefacts to close the identified knowledge gaps and expand knowledge base.

The above discussed intelligent knowledge extraction from artifacts by transition planning module 10 employs natural language processing technique. A speech recognition sub-module allows speech recognition and knowledge extraction from audio/video files. Likewise, natural language understanding technique is utilized for intent classification and entity extraction. Optical character recognition technology allows recognition of text within a digital image.

Now, moving to knowledge analytics module 20, an extensive knowledge search is performed and knowledge graph is generated for a specific transition such that a quick inference can be drawn from the artifacts gathered. In one exemplary embodiment, the knowledge graph provides all relevant information including customer details, artifacts provided by customer and identified gaps across all categories. Thus, the knowledge bot application 100 is equipped to identify and prompt user on knowledge gaps. Hereon, transition can be managed to overcome knowledge gaps and sync or async knowledge transfer WebEx/audio recordings to mitigate the knowledge gap. In one example embodiment, elastic search is used for searching, and analyzing huge volumes of data quickly and in near real time. Necessary information is collected and provided to the user regarding knowledge areas for a particular application.

In next working embodiment, the knowledge generation module 30 is configured to search on any of inquired subject area across applications. The knowledge generation module 30 further enables image analytics along with search and displays a transcript along with document content. The search expands and provides a detailed content on any type of availed content (text, image etc.).

Finally, the knowledge transition status is rendered over a dashboard 40 that depicts a detailed status of knowledge acquisition happening for any specific transition. In one other aspect, the dashboard 40 details out overall document percentage received and knowledge extraction percentage for ingested documents. Further, percentage of knowledge extracted for categories-technical, functional, operational, process, infrastructure is also presented. In addition, document quality index based on information ingested and extracted can also be computed and displayed along with percent of transition completion status and associated timelines.

In one significant aspect of present disclosure, the system 100 comprises of an AI powered chat bot built with RASA framework configured to respond to specific user queries. The chat bot is user interactive and has an ability to respond to specific user queries. Most importantly, the user queries are answered as the bot identifies the intent of the chat to generate a qualified response.

In accordance with next working embodiment, knowledge buddy bot application may be deployed on a secured cloud service platform. Now, a functional description of AI based bot application 100 exhibiting knowledge transition is illustrated. Accordingly, a machine learning model is trained, basis which the knowledge bot application 100 is developed.

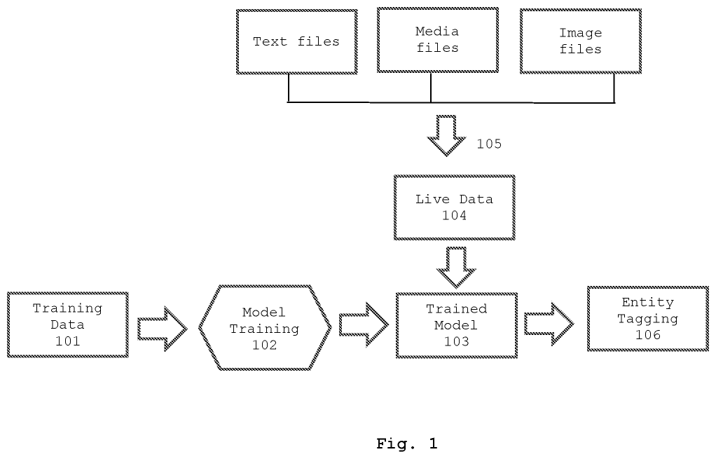

Referring to FIG. 1, training data consisting of labeled text corpus is prepared to train model of bot application 100 in step 101. The training data comprises several instances of text (context) for a particular subtext tagged to a particular entity. In one exemplary embodiment, a snippet of training data showing subtext “Support hours” being mapped to entity “Support coverage” is shown where the text column provides relevant context. Precisely, a typical training set contains several instances of text (setting the context) for a particular subtext tagged to a particular entity as shown in Table 1 below.

TABLE 1

| | | | | |
|---|---|---|---|---|
| idx | Text | subtext | span | entity |

| | | | |
|---|---|---|---|
| 1 | Support Hours | Support | Support |
| | Customer Service Desk: 24 hours a day, 5 days a | Hours | Coverage |
| | week | | |
| | Application Support: End user will contact | | |
| | Application | | |
| | Support/Service Desk team for any issue. | | |
| | Application Support team will investigate the | | |
| | issue. If they are not able to fix it then that issue | | |
| | will be assigned to Development team with | | |
| | observation done by Application support team | | |
| 2 | Support Hours | Support | Support |
| | Customer Service Desk: 24 hours a day, 5 days a | Hours | Coverage |
| | week | | |
| 3 | Support Hours | Support | Support |
| | Application Support: End user will contact | Hours | Coverage |
| | Application | | |
| | Support/Service Desk team for any issue. | | |
| | Application support team will investigate the | | |
| | issue. If they are not able to fix it then that issue | | |
| | will be assigned to Development team with | | |
| | observation done by Application support team | | |
| 4 | Support Hours | Support | Support |
| | Customer Service Desk: 24 hours a day, 5 days a | Hours | Coverage |
| | week | | |
| | Application Support: End user will contact | | |
| | Application | | |
| | Support/Service Desk team for any issue. | | |
| | Application Support team will investigate the | | |
| | issue. If they are not able to fix it then that issue | | |
| | will be assigned to Development team with | | |
| | observation done by Application support team | | |
| 5 | Support Hours | Support | Support |
| | Customer Service Desk: 24 hours a day, 5 days a | Hours | Coverage |
| | week | | |
| 6 | Support Hours | Support | Support |
| | Application Support: End user will contact | Hours | Coverage |
| | Application | | |
| | Support/Service Desk team for any issue. | | |
| | Application support team will investigate the | | |
| | issue. If they are not able to fix it then that issue | | |
| | will be assigned to Development team with | | |
| | observation done by Application support team | | |

In next preferred embodiment, approach for training the model of knowledge buddy bot application 100 is discussed, shown in step 102 of FIG. 1. Fundamentally, the model is trained using a Named Entity Recognition (NER) trainer. In one working embodiment, ExcelCy toolkit is utilized that uses spaCy framework to match Entity with PhraseMatcher or Matcher in regular expression. The spacy framework is thus employed as a NER trainer to annotate the subtext with the text and also extract the contextually relevant information from the input information along with the model.

The trained model, shown in step 103, is fed with untrained live data fetched from various sources (as discussed above in transition panning module 10) in different formats in step 104. The live training data may be in form of text or files such as PDF, DOCX, PPT, PNG or JPG that may be parsed using any application capable of extracting text from any such document, shown by 105. In one preferred embodiment, textract may be used to automatically extract text from wide variety of structured documents in any given format.

Expanding on type of input files received for model execution phase, any type of input file can be accommodated, be it any of:

a) text file (files of formats ‘docx’, ‘doc’, ‘txt’, ‘pdf’ & ‘xlsx’)

b) media file (Files of format ‘wav’, ‘mp4’, ‘m4a’ & ‘mp3’). Here, the file format is first converted to ‘Wav’ format and is then fed to a speech recognition submodule such as Kaldi, written in C++ that uses weighted finite state transducers (FSTs) toolkit such as OpenFST for decoding the received file type.

c) image file (Files of format jpg′, ‘jpeg’ & ‘png’). These are converted to plain text with the help of optical character recognition, which is a branch of computer vision. For this, first the image is preprocessed using CV2 (openCV) and then fed to python-tesseract, which is a wrapper for Google's Tesseract—OCR engine that enables detection of string from the images.

d) text files and transcripts for the media/image files—these are converted to docx file format and then fed to Textract, which obtains text from the documents automatically in an efficient manner. E.g. model leverages natural language processing (NLP) for intelligent knowledge extraction from transition artifacts/documents, related to multiple applications in any format (doc, docx, xls etc.). Thus, text extracted using textract is fed to NLP (natural language processing) model to check if the fed input document covers relevant entity information for knowledge transition.

In accordance with one specific embodiment of present disclosure, the trained model of knowledge bot application 100 is configured to read documents from a plurality of sources (local/ftp/confluence).

Once the input fed to Textract is processed into a suitable output, the output is fed to Named Entity Recognition (NER) training model of bot application 100 as an untrained live data, from which information is extracted and entities are tagged to the text, shown in step 106. Once the model is trained, it builds its own deep learning library for text analysis. In one preferred embodiment, Spacy platform is deployed for NER, for which it uses a framework called Embed. Encode. Attend. Predict to parse the fed data and extract information therefrom by tagging texts to relevant entities.

The embed process involves embedding words using a bloom filter, which means that word hashes are kept as keys in the embedding dictionary, instead of the word itself. This maintains a more compact embeddings dictionary, with words potentially colliding and ending up with the same vector representations. Next, the encode process involves encoding a list of words into a sentence matrix to take context in account. In accordance with one exemplary embodiment, Spacy employs convolutional neural network (CNN) for encoding.

Followed by encoding process, attend process decides which parts are more informative given a query, and get problem specific representations. Thereafter, the predict process uses a multi-layer perceptron for inference. SpaCy NER already supports the entity types like—PERSON-People, including fictional, NORP-Nationalities or religious or political groups, FAC-Buildings, airports, highways, bridges, etc. ORG-Companies, agencies, institutions, etc. GPE-Countries, cities, states, etc. Further, this model is trained to incorporate custom entities present in any specific dataset. In one exemplary embodiment, an english base model is used and new entity label is added to the entity recognizer. Finally, live untrained data is fed to model as input, which then parses this data and extracts information by tagging texts to relevant entities.

The model of knowledge bot application 100 now picks relevant subtext such as “support hours” in above illustrated example, on the basis of context and tags it to entity “Support Coverage”, which is further categorized into a subcategory—Operational Knowledge (shown in above example). Consequently, availability of knowledge is checked and displayed on dashboard 40.

Precisely, to summarize above, the machine learning model is built and trained by creating a trained data set constituted of a customized corpus of entities by way of annotating a subtext with a corresponding text of an input training data. Next, the machine learning model is constructed from the trained data set by utilizing a named entity recognition engine. Finally, the machine learning model is used to extract the contextually relevant data and check the availability of entities to identify the knowledge gaps based on learnings from the trained data set.

It is important to note that machine learning model is trained at predetermined intervals to update the trained built-in library, such that the updated trained built-in library can be accessed for performing next set of knowledge search and eventually knowledge transition. These intervals may be user determined and an important feature to ensure the learned information during the course of training is not lost, and instead used for dynamically updating the model for performing knowledge transition during the next cycle more efficiently.

The present computer system 100 embodies various modules in which various embodiments of the present invention may be implemented. The computer system 100 comprises a processor 110 and a memory 120. The processor 110 executes program instructions and is a real processor. The computer system 100 is not intended to suggest any limitation as to scope of use or functionality of described embodiments. For example, the computer system 100 may include, but not limited to, a programmed microprocessor, a micro-controller, a peripheral integrated circuit element, and other devices or arrangements of devices that are capable of implementing the steps that constitute the method of the present invention.

In an embodiment of the present invention, the memory 120 may store software for implementing various embodiments of the present invention. The computer system 100 may have additional components. For example, the computer system 100 includes one or more communication channels 130, one or more input devices 140, one or more output devices 150, and storage 160. An interconnection mechanism (not shown) such as a bus, controller, or network, interconnects the components of the computer system 100. In various embodiments of the present invention, operating system software (not shown) provides an operating environment for various softwares executing in the computer system 100, and manages different functionalities of the components of the computer system 100.

The communication channel(s) 130 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 140 may include, but not limited to, a keyboard, mouse, pen, joystick, trackball, a voice device, a scanning device, touch screen or any another device that is capable of providing input to the computer system 100. In an embodiment of the present invention, the input device(s) 140 may be a sound card or similar device that accepts audio input in analog or digital form. The output device(s) 150 may include, but not limited to, a user interface on CRT or LCD, printer, speaker, CD/DVD writer, or any other device that provides output from the computer system 100.

The storage 160 may include, but not limited to, magnetic disks, magnetic tapes, CD-ROMs, CD-RWs, DVDs, flash drives or any other medium which can be used to store information and can be accessed by the computer system 100. In various embodiments of the present invention, the storage 160 contains program instructions for implementing the described embodiments.

The foregoing description is a specific embodiment of the present disclosure. It should be appreciated that this embodiment is described for purpose of illustration only, and that those skilled in the art may practice numerous alterations and modifications without departing from the spirit and scope of the invention. It is intended that all such modifications and alterations be included insofar as they come within the scope of the invention as claimed or the equivalents thereof.

We claim:

1. A system for knowledge transition, comprising:
a processor executing program instructions stored in a memory;
a transition planning module, implemented upon the processor, configured to:
ingest information in a given format from a plurality of sources;
extract contextually relevant information from the ingested information to check availability of one or more knowledge areas in a trained built-in library for complete knowledge transition, and
identify knowledge gaps based on unavailability of the one or more knowledge areas,
wherein the transition planning module is configured to operate on an underlying machine learning model to extract the contextually relevant information and construct the trained built-in library.

2. The system for knowledge transition as claimed in claim 1, further comprising a knowledge analytics module, implemented upon the processor, configured to perform knowledge search requested for a knowledge area and generate a corresponding knowledge graph providing detailed analytics therefor.

3. The system for knowledge transition as claimed in claim 1, further comprising a knowledge generation module, implemented upon the processor, configured to generate synopsis of all extracted information and associated knowledge gaps.

4. The system for knowledge transition as claimed in claim 1, further comprising a dashboard configured to render status of knowledge acquisition for a specific knowledge transition along with associated timelines.

5. The system for knowledge transition as claimed in claim 1, wherein the machine learning model is built and trained in steps of:
creating a trained data set constituted of a customized corpus of entities by way of annotating a subtext with a corresponding text of an input training data;
constructing the machine learning model from the trained data set by utilizing a named entity recognition engine; and
using the machine learning model to extract the contextually relevant data and checking the availability of entities to identify the knowledge gaps based on learnings from the trained data set.

6. The system for knowledge transition as claimed in claim 5, wherein Spacy platform is deployed as the named entity recognition engine configured to:
annotate the subtext with the text of the input training; and
extract the contextually relevant information from the ingested information along with the machine learning model.

7. The system for knowledge transition as claimed in claim 1, wherein the contextually relevant information ingested from a plurality of sources and supporting artifacts is in the file format selected from a group comprising of, but not limited to, a text file, an image file, a media file, a.docx file, a ppt file, an audio, or a video file.

8. The system for knowledge transition as claimed in claim 1, wherein the ingested information of the given format is converted to a textual information for intelligent and dynamic knowledge extraction therefrom, wherein
the textual information is extracted from an image file format using a computer vision recognition technique; and
the textual information is extracted from an audio and video file format using speech to text technique.

9. The system for knowledge transition as claimed in claim 1, wherein the transition planning module is configured to identify source type of the file in given format.

10. The system for knowledge transition as claimed in claim 1, wherein the availability of one or more knowledge areas is ascertained across categories selected from a group comprising of, but not limited to, process, functional, operational, technical, and infrastructure.

11. The system for knowledge transition as claimed in claim 1, wherein the transition planning module is further configured to:
create a book of knowledge in an event of one or more entities inquired for are unavailable in the knowledge areas, and
re-train the machine learning model at predetermined intervals to update the trained built-in library.

12. The system for knowledge transition as claimed in claim 11, wherein the book of knowledge is generated based on application domain, one or more standard key terms associated therewith, application group, knowledge area categories and appended to the trained built-in library.

13. The system for knowledge transition as claimed in claim 1, wherein the knowledge analytics module employs elastic search technique to perform the knowledge search and provide a detailed content on the requested for knowledge area.

14. The system for knowledge transition as claimed in claim 1, wherein a light version of the system for knowledge transition is availed as an extension by an external party to obviate data privacy risks.

15. The system for knowledge transition as claimed in claim 1, further comprising an AI powered chat bot built with RASA framework configured to respond to contextually relevant specific user queries.

16. A process for knowledge transition, comprising:
ingesting information in a given format from a plurality of sources;
extracting contextually relevant information from the ingested information to check availability of one or more knowledge areas in a trained built-in library for complete knowledge transition, and
identify knowledge gaps based on unavailability of the one or more knowledge areas,
wherein the contextually relevant information is extracted by utilizing a machine learning model to further construct the trained built-in library.

17. The process as claimed in claim 16, further comprising:
performing knowledge search requested for a knowledge area; and
generating a corresponding knowledge graph providing detailed analytics therefor.

18. The process as claimed in claim 16, further comprising generating a synopsis of all extracted information and associated knowledge gaps.

19. The process as claimed in claim 16, further comprising rendering status of knowledge acquisition for a specific knowledge transition along with associated timelines.

20. The process as claimed in claim 16, wherein the machine learning model is built and trained in steps of:
creating a trained data set constituted of a customized corpus of entities by way of annotating a subtext with a corresponding text of an input training data;
constructing the machine learning model from the trained data set by utilizing a named entity recognition engine; and
using the machine learning model to extract the contextually relevant data and checking the availability of entities to identify the knowledge gaps based on learnings from the trained data set.

21. The process as claimed in claim 20, wherein Spacy platform is deployed for:
annotating the subtext with the text of the input training; and
extracting the contextually relevant information from the ingested information along with the machine learning model.

22. The process as claimed in claim 16, wherein the contextually relevant information ingested from a plurality of sources and supporting artifacts is in the file format selected from a group comprising of, but not limited to, a text file, an image file, a media file, a.docx file, a ppt file, an audio, or a video file.

23. The process as claimed in claim 16, wherein the ingested information of the given format is converted to a textual information for intelligent and dynamic knowledge extraction therefrom, wherein
the textual information is extracted from an image file format using a computer vision recognition technique; and
the textual information is extracted from an audio and video file format using speech to text technique.

24. The process as claimed in claim 16, wherein the availability of one or more knowledge areas is ascertained across categories selected from a group comprising of, but not limited to, process, functional, operational, technical, and infrastructure.

25. The process as claimed in claim 16, further comprising:
creating a book of knowledge in an event of one or more entities inquired for are unavailable in the knowledge areas, and
re-training the machine learning model at predetermined intervals to update the trained built-in library.

26. The process as claimed in claim 25, wherein the book of knowledge is generated based on application domain, one or more standard key terms associated therewith, application group, knowledge area categories and appended to the trained built-in library.

27. The process as claimed in claim 16, wherein the knowledge search is performed using elastic search technique to provide a detailed content on the requested for knowledge area.

28. The process as claimed in claim 16, wherein a light version of knowledge process transition process is availed as an extension by an external party to obviate data privacy risks.

29. The process as claimed in claim 16, comprising identification of source type of the file in given format.

30. The process as claimed in claim 16, further comprising a chatbot feature to respond to specific user queries by using RASA framework.
